(19) United States
(12) Patent Application Publication
(10) Pub. No.: US 2021/0171864 A1
(43) Pub. Date: Jun. 10, 2021

(54) Soaping Agent And Preparation Method And Application Thereof

(71) Applicants: Tianjin Zhongtian Jingke Technology Co., Ltd., Tianjin (CN); Tiangong University, Tianjin (CN)

(72) Inventors: ZHENG LI, Tianjin (CN); JIA LIU, Tianjin (CN); Fengyan LI, Tianjin (CN); WENYU LU, Tianjin (CN); JIXIAN GONG, Tianjin (CN); JIANFEI ZHANG, Tianjin (CN); QIUJIN LI, Tianjin (CN)

(21) Appl. No.: 17/178,237

(22) Filed: Feb. 17, 2021

Related U.S. Application Data
(63) Continuation of application No. PCT/CN2020/118021, filed on Sep. 27, 2020.

(30) Foreign Application Priority Data
Sep. 29, 2019 (CN) 201910931728.9

(51) Int. Cl. C11D 1/66; C11D 1/22; C11D 3/37

(52) U.S. Cl. CPC C11D 1/662; C11D 3/3776; C11D 1/22

(57) ABSTRACT

The invention relates to an environment-friendly soaping agent for dyeing cotton fabrics with reactive dyes and a preparation method and application thereof, belonging to the technical field of textiles. The invention provides a soaping agent which comprises the following raw materials in parts by weight: 1-9 parts of sophorolipid, 1-9 parts of anionic surfactant and 1-9 parts of soaping auxiliary, wherein the anionic surfactant is either sodium dodecyl benzene sulfonate or rhamnolipid. According to the invention, the combination of sophorolipid, anionic surfactant and soaping auxiliary can effectively improve the fastness to soaping and fastness to rubbing of fabrics; and meanwhile, the soaping agent is environment-friendly and biodegradable, and has a wide application prospect.

### CROSS REFERENCE TO RELATED APPLICATION

This application is a U.S. National Stage Entry of PCT Application with No. PCT/CN2020/118021, filed on Sep. 27, 2020, which claims the priority of the Chinese patent application filed in China Patent Office on Sep. 29, 2019, with the application number of CN201910931728.9 the entire contents of which are incorporated herein by reference.

### TECHNICAL FIELD

The invention relates to the technical field of textiles, in particular to an environment-friendly soaping agent and a preparation method and application thereof.

### BACKGROUND ART

Reactive dyes are widely used because of their good color brightness, complete chromatography and low price. However, when dyeing cellulose fibers with reactive dyes, it is prone to form floating colors, which may be due to the following three reasons: a. When dyeing cellulose fibers with reactive dyes, some dyes are dyed on the fabric and combined with it by Van der Waals' force, while the other dyes are hydrolyzed under alkaline conditions to form hydrolyzed dyes; b. If the dye is used too much, it will accumulate on the fabric surface in the form of multi-molecular layer association complex, so that only the bottom dye molecules can react with cellulose fibers for dyeing; c. Carbon atoms and active chlorine atoms in dye molecules are difficult to avoid freely when they undergo dissociation reaction, and “steric hindrance” phenomenon is prone to occur, which makes the dye fixation rate decrease and form floating color again. Reactive dye soaping agent plays an important role in improving the washing fastness of dyed fabrics and removing hydrolyzed dyes from fabrics. At present, the soaping agents used in industry are mainly surfactants and their compounds.

“Low-temperature Soaping Agent for Cellulose Reactive Dyes”, with the publication number of CN109989280A, relates to the technical field of textile printing and dyeing. This invention is compounded with anionic Gemini surfactants, polymer and other auxiliaries, and consists of the following components in percentage by weight: 1%-20% of sodium dialkyldiphenyl ether disulfonate, 5%-15% of anionic surfactant AOT, 0.1%-0.5% of defoaming agent and 0.1%-5% of β-cyclodextrin, 0.2%-2% of sodium polyacrylate, 1%40% of polyvinyl pyrrolidone, and deionized water allowance. The soaping agent has low foam and strong hard water resistance, and has obvious effect of soaping at 60° C. to remove floating color. It has good energy conservation and emission reduction, and is of positive significance for solving the problem of high energy consumption in printing and dyeing industry.

In the prior art, chemical soaping agent is often added in the soaping process, which increases the burden of waste water treatment, directly affects the energy saving, emission reduction and environmental protection of dyeing, and causes environmental pollution.

Although biodegradable soaping agents are disclosed in the prior art, such as in CN102911807A, a preparation method for an anti-staining soaping agent for reactive dye printing on white ground, characterized by comprising the following steps: A. sequentially adding fatty alcohol polyoxyethylene ether −9 and water into a compounding kettle, heating to 30-50° C., and stirring for 0.5-1 hour to dissolve; B. adding poly-4-hydroxytetramethylene 1,2-dicarboxylic acid (CP2), dodecyl dimethyl betaine, lauryl polyether −9 ammonium sulfate, carboxymethyl hydroxypropyl cellulose, EDTA disodium salt and sodium metasilicate into the solution obtained in step A under vigorous stirring, then adding a certain amount of water, and stirring at 40-60° C. for 0.5-2 hours to obtain an optimized soaping agent product with an active content of 25%. The soaping agent prepared according to the invention has excellent cleaning performance, strong anti-contamination ability, good biodegradability, moderate price, good safety and environmental protection, and can replace similar foreign products. However, it also uses soaping agent with chemical reagent as its main component, which is also polluting in production.

### SUMMARY OF THE INVENTION

The invention provides a soaping agent for washing textiles, which realizes the application of a low-toxic and environment-friendly biosurfactant sophorolipid in soaping cotton fabrics dyed with reactive dyes, so as to slow down or reduce the environmental pollution caused by liquid waste of soaping cotton fabrics.

According to the complete technical solution provided by the invention, the soaping agent comprises the following raw materials in parts by weight: 1-9 parts of sophorolipid, 1-9 parts of anionic surfactant and 1-9 parts of soaping auxiliary, the anionic surfactant is either sodium dodecyl benzene sulfonate or rhamnolipid.

In further embodiments, the anionic surfactant is sodium dodecyl benzene sulfonate, and the weight ratio of sophorolipid to sodium dodecyl benzene sulfonate is 7-9:1-3.

In further embodiments, the anionic surfactant is sodium dodecyl benzene sulfonate, and the weight ratio of the sophorolipid to sodium dodecyl benzene sulfonate is 8:2.

In further embodiments, the soaping auxiliary is polyvinyl pyrrolidone.

In further embodiments, the anionic surfactant is sodium dodecyl benzene sulfonate, and the weight ratio of sophorolipid, sodium dodecyl benzene sulfonate and polyvinyl pyrrolidone is 7-9:1-3:4-6.

In further embodiments, the anionic surfactant is sodium dodecyl benzene sulfonate, and the weight ratio of sophorolipid, sodium dodecyl benzene sulfonate and polyvinyl pyrrolidone is 8:2:5.

In further embodiments, the anionic surfactant is rhamnolipid, and the weight ratio of sophorolipid to rhamnolipid is 1-3:7-9.

In further embodiments, the anionic surfactant is rhamnolipid, and the weight ratio of sophorolipid o rhamnolipid is 2:8.

In further embodiments, the anionic surfactant is rhamnolipid, and the weight ratio of sophorolipid, rhamnolipid and polyvinyl pyrrolidone is 1-3:7-9:4-6.

In further embodiments, the anionic surfactant is rhamnolipid, and the weight ratio of sophorolipid, rhamnolipid and polyvinyl pyrrolidone is 2:8:5.

The present invention also provides a preparation method of the soaping agent as described above, which specifically comprises the following steps: compounding sophorolipid, anionic surfactant and soaping auxiliary in proportion, and shaking the solution to be uniformity mixed.

The present invention further provides the use of the above soaping agent in soaping process.

In further embodiments, thesoaping process comprises the steps of hot water washing, cold water washing, soaping agent soaping and cold water washing again.

Preferably, the total concentration of the soaping agent system is 1.0 g/L-5.0 g/L. The total concentration of the soaping agent system can be 1.0 g/L, 1.1 g/L, 1.2 g/L, 1.3 g/L, 1.4 g/L, 1.5 g/L, 1.6 g/L, 1.7 g/L, 1.8 g/L, 1.9 g/L, 2.0 g/L, 2.1 g/L, 2.2 g/L, 2.3 g/L, 2.4 g/L, 2.5 g/L, 2.6 g/L, 2.7 g/L, 2.8 g/L, 2.9 g/L, 3.0 g/L, 3.1 g/L, 3.2 g/L, 3.3 g/L, 3.4 g/L, 3.5 g/L, 3.6 g/L, 3.7 g/L, 3.8 g/L, 3.9 g/L, 4.0 g/L, 4.1 g/L, 4.2 g/L, 4.3 g/L, 4.4 g/L, 4.5 g/L, 4.6 g/L, 4.7 g/L, 4.8 g/L, 4.9 g/L, 5.0 g/L.

More preferably, the total concentration of the soaping agent system is 1.5 g/L-3.0 g/L.

Preferably, in the step of soaping agent soaping, the soaping ratio is 1:10-30.

Preferably, in the step of soaping agent soaping, the soaping time is 15 min-25 min.

Preferably, in the step of soaping agent soaping, the soaping temperature is 60-80° C.

Preferably, in the step of hot water washing, the temperature is 50-60° C., the time is 5-10 min, and the liquor ratio is 1:50-1:80.

Preferably, in the step of cold water washing, the temperature is 20-30° C., the time is 5-10 min, and the liquor ratio is 1:50-1:80.

The invention has the following beneficial effects:

The chemical soaping agent used in the traditional soaping process increases the burden of waste water treatment, directly impacts the energy saving, emission reduction and environmental protection of dyeing, and causes environmental pollution. Moreover, water pollution and water consumption are two major challenges for the sustainable development of textile printing and dyeing industry. As a soaping agent, sophorolipid is obtained through biological fermentation, which is environmentally friendly from production to application, and can effectively reduce the use of water resources in the process of production, application and degradation.

The sophorolipid selected by the invention has directional adsorption effect on the floating color on the fabric surface, and penetrates between the floating color and the fiber by reducing the interfacial tension, thereby weakening the adhesion of the floating color on the fiber and having better emulsification and dispersion effects. Sophorolipid is the most promising type of biosurfactant among glycolipid biosurfactants, which is extremely low in biological toxicity, environmentally friendly and biodegradable, suitable for extreme temperature, pH and salinity, and has good biocompatibility, and usually doesn't cause allergy. In recent years, the biosurfactant sophorolipid has been widely applied in daily chemical, medicine, environmental engineering and other fields. However, the application of sophorolipid as soaping agent in soaping process of dyed cotton fabric has not been reported.

According to the invention, sophorolipid is used as a soaping agent for soaping, and the soaping agent has a directional adsorption effect on the floating color on the fabric surface, and penetrates between the floating color and the fiber by reducing the interfacial tension, thereby weakening the adhesion of the floating color on the fiber and having better emulsification and dispersion effects. Sophorolipid is environmentally friendly, and its biodegradability is higher than that of conventional soaping lotions.

Degradability of sophorolipid: Chemical Oxygen Demand (COD) of 1 g/L of sophorolipid is 1655 mg/L, and COD of sodium dodecyl benzene sulfonate with the same concentration is as high as 2685 mg/L. The smaller the COD value, the lighter the water pollution degree and the better the degradability. When the ratio of BOD (Biochemical Oxygen Demand) to COD is greater than 0.3, the biodegradability is better. The BOD/COD of sophorolipid is 0.44, while that of sodium dodecyl benzene sulfonate is 0.28, which indicates that the biodegradability of sophorolipid is more remarkable.

The compounding of sophorolipid and anionic surfactant is the molecular interaction between nonionic surfactant and ionic surfactant. Considering from the structure, it is mainly the ion-dipole interaction between polarities. Non-anionic surfactant compound system has three synergistic effects: (1) the synergy of micelle formation ability; (2) the synergy of reducing surface tension efficiency; (3) the synergy of reducing surface tension ability. While soaping auxiliary is added into the compound system, the soaping auxiliary plays a major role in increasing the activity of the compound system, and plays the roles of decontamination, dispersion, emulsification and solubilization. Moreover, sophorolipid is environmentally friendly, and its biodegradability is higher than that of conventional soaping agent.

Advantages of sophorolipid and its compound system in soaping: firstly, the sophorolipid will adsorb on the fiber surface and penetrate into the fiber gap, and reduce its binding force by reducing the surface tension between the unfixed dye, hydrolyzed dye and the fiber, and then make the unfixed dye and hydrolyzed dye separate from the fiber by mechanical stirring. After the sophorolipid is compounded with sodium dodecyl benzene sulfonate or rhamnolipid, the wettability and emulsibility of the sophorolipid can be effectively improved, and the surface activity of the sophorolipid can be improved, thus the original soaping performance can be achieved at a low concentration. The soaping auxiliary plays an anti-contamination role, thus preventing the floating color from being recombined with the fiber. The combination of sophorolipid, anionic surfactant (sodium dodecyl benzene sulfonate or rhamnolipid) and soaping auxiliary can further effectively improve the soaping fastness and crockfastness.

### BRIEF DESCRIPTION OF THE DRAWINGS

FIG. 1 is a dyeing process diagram of an embodiment of the invention.

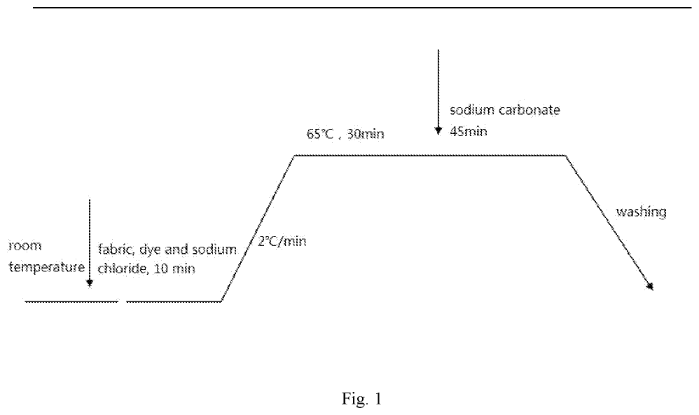

### DETAILED DESCRIPTION OF THE INVENTION

The invention is described below through specific embodiments. Unless otherwise specified, the technical means used in the invention are all methods known to those skilled in the art. In addition, the embodiments should be understood as illustrative rather than limiting the scope of the invention, and the essence and scope of the invention shall be limited only by the claims. For those skilled in the art, without departing from the essence and scope of the invention, various changes or modifications made to the material compositions and amounts in these embodiments also belong to the protection scope of the invention. The invention will be further described below in conjunction with specific embodiments.

The dyeing process of soaped fabrics selected in the following experimental examples and embodiments is as follows:

Dyeing formula: 2% (owf) of reactive red SNE (M-type reactive dye with dual reactive groups of monochlorotriazinyl and vinyl sulfone), 60 g/L of sodium chloride, 15 g/L of sodium carbonate, with a liquor ratio of 1:30. Dyeing process conditions: the specific process flow of dyeing cotton fabric with reactive dye is as follows: fabric, dye and sodium chloride are added and mixed according to the above ratio at a room temperature of 25-30° C. for 10 min, the temperature is then raised to 65° C. at a rate of 2° C./min, after being heated at a constant temperature for 35 min, sodium carbonate is added and mixed, the mixture is continually treated at a constant temperature of 65° C. for another 45 min, after finish heating, soaping and water washing in the following experimental examples and embodiments are carry out.

The methods for testing the color fastness to soaping and rubbing in the following embodiments and experimental examples are as follows:

(1) Test for Color Fastness to Soaping

The color fastness to soaping of dyed fabrics is tested according to the national standard GB/T 3920-2008 “Textiles—Tests for colour fastness—Colour fastness to soaping”. A sample of 100×40 mm is taken and sandwiched between two standard lining fabrics of 100×40 mm, and stitched along a short side. Firstly, the steel can filled with soap solution is put into a SW-10 color-fastness-to-soaping tester for preheating. After the temperature reaches 40±2° C., the sample to be tested is put into the steel can, in which the concentration of soap solution is 5 g/L and the soaping liquor ratio is 1:50. The steel can is fixed in the color-fastness-to-soaping tester, and mechanically stirred at 40° C. for 30 min. After soaping, the sample to be tested is taken out for washing and drying. The first piece of the standard lining fabric is made of cotton fiber, and the second piece is made of wool fiber. Taking the original sample and the original standard lining fabric as reference, the color change of the sample and the staining grade of the lining fabric are evaluated with a grey scale.

(2) Test for Color Fastness to Rubbing

According to the national standard GB/T 3920-2008 “Textiles—Tests for colour fastness—Colour fastness to rubbing”, the color fastness to rubbing of dyed fabrics is tested. Two samples of 50×200 mm are taken for dry rubbing test and wet rubbing test (the moisture content in wet rubbing reaches 98%). A standard rubbing cotton cloth of 50×50 mm is used for rubbing head.

Measurement of color fastness to dry rubbing: the sample is fixed on a platform of Y571L dyeing color-fastness-to-rubbing tester with a clamping device, so that the length direction of the sample is consistent with the running direction of the rubbing head (cylinder with a diameter of 16±0.1 mm). The running speed is 1 reciprocating rubbing cycle per second, with a total of 10 cycles of rubbing. The rubbing stroke is 104±3 mm, and the downward pressure applied is 9±0.2N. After the test, the sample to be tested and the standard rubbing cotton cloth are taken off, and the grey scale for staining is used to evaluate the staining grade of the rubbing cloth.

Measurement of color fastness to wet rubbing: the standard rubbing cotton cloth is weighed, then immersed completely in distilled water, and an adjustable rolling device is used to remove excess water from the cotton cloth, and the rubbing cloth is weighed again to ensure that the moisture content of the rubbing cloth reaches 95%-100%. Then test is carried out according to the test method of color fastness to dry rubbing. After the test, the wet rubbing cloth is dried. Finally, the gray scale is used for staining to evaluate the staining grade of the rubbing cloth.

### Experimental Example 1: Influence of Time on Soaping Effect of Sophorolipid

A soaping process comprising hot water washing, cold water washing, soaping agent soaping and cold water washing again.

The soaping agent was sophorolipid with a mass concentration of 2 g/L.

In the step of soaping agent soaping, the soaping liquor ratio was 1:30, and the soaping temperature was 80° C.

In the step of hot water washing, the temperature was 55° C., the time was 5 min, and the liquor ratio was 1:50.

In the step of cold water washing, the temperature was 25° C., the time was 5 min, and the liquor ratio was 1:50.

The cotton fabrics dyed with reactive dyes according to the above soaping method were soaped, and grouped according to different soaping time, in which the corresponding soaping time of experimental groups 1, 2 and 3 were 15 min, 20 min and 25 min, respectively.

The corresponding soaping time of control group 1 and 2 were 10 min and 30 min, respectively.

The absorbance of the soaping residue was measured, and then the concentration of dye in the soaping residue was calculated according to the standard curve of reactive dyes.

TABLE 1
Influence of time on soaping effect of sophorolipid

| | Concentration of soaping |
|---|---|
| Time (min) | residue (mg/L) |
| Experimental group 1: 15 | 15.87 |
| Experimental group 2: 20 | 17.24 |
| Experimental group 3: 25 | 17.60 |
| Control group 1: 10 | 12.48 |
| Control group 2: 30 | 17.69 |

It can be seen from the above table that with the increase of soaping time, the concentration of soaping residue first increases and then tends to level off. When the soaping time is 20 min, the sophorolipid has achieved good soaping effect on cotton fabrics.

### Experimental Example 2: Influence of Temperature on Soaping Effect of Sophorolipid

A soaping process comprising the steps of hot water washing, cold water washing, soaping agent soaping, and cold water washing again.

The soaping agent was sophorolipid with a mass concentration of 2.0 g/L.

In the step of soaping agent soaping, the soaping liquor ratio was 1:30, and the soaping time was 20 min.

In the step of hot water washing, the temperature was 55° C., the time was 5 min, and the liquor ratio was 1:50.

In the step of cold water washing, the temperature was 25° C., the time was 5 min, and the liquor ratio was 1:50.

Cotton fabrics dyed with reactive dyes were soaped according to the above soaping method, and were grouped according to different soaping temperatures, in which the soaping temperatures of experimental groups 1, 2 and 3 were 60° C., 70° C. and 80° C., respectively;

The soaping temperatures of control group 1 and 2 were 50° C. and 90° C., respectively;

The absorbance of soaping residue was measured, and then the concentration of dye in soaping residue was calculated according to the standard curve of reactive dyes.

TABLE 2
Influence of temperature on soaping effect of sophorolipid

| | Concentration of soaping |
|---|---|
| Temperature (° C.) | residue (mg/L) |
| Experimental group 1: 60 | 7.70 |
| Experimental group 2: 70 | 11.01 |
| Experimental group 3: 80 | 17.29 |
| Control group 1: 50 | 6.87 |
| Control group 2: 90 | 17.42 |

It can be seen from the above table that temperature has a relatively large influence on the soaping effect. When the soaping temperature is 50° C., the concentration of soaping residue is 6.87 mg/L, while the concentration of soaping residue at 80° C. reaches 17.29 mg/L, which is almost the same as the soaping effect at 90° C. Reactive dyes have high directness, and can combine with cotton fibers with their affinity for cotton fibers. Most dyes exist in the inner pores of fibers, and a small amount of dyes adhere to the fiber surface. The higher the soaping temperature is, the more fully the fiber swells, and the dye diffusion coefficient will be improved correspondingly, which is beneficial to the desorption of reactive dyes which are not completely fixed in the fiber inner channel and their diffusion to the fiber surface. The reactive dyes on the fiber surface are removed because of the concentration difference with water and the dispersibility of sophorolipid.

### Experimental Example 3: Influence of Sophorolipid (SL)/Sodium Dodecyl Benzene Sulfonate (SDBS) Compound System on Soaping Effect

A soaping process comprising the steps of hot water washing, cold water washing, soaping agent soaping, and cold water washing again.

The total concentrations of soaping agent systems in experimental group and control group were 2.0 g/L.

In the step of soaping agent soaping, the soaping liquor ratio was 1:30, the soaping time was 20 min, and the soaping temperature was 80° C.

In the step of hot water washing, the temperature was 55° C., the time was 5 min, and the liquor ratio was 1:50.

In the step of cold water washing, the temperature was 25° C., the time was 5 min, and the liquor ratio was 1:50.

Cotton fabrics dyed with reactive dyes were soaped according to the above soaping method, and were grouped according to different soaping agents. The weight ratio of sophorolipid to sodium dodecyl benzene sulfonate in compound systems of experimental groups 1, 2, and 3 were 7:3, 8:2 and 9:1, respectively.

Control group 1: sodium dodecyl benzene sulfonate;

Control group 2: sophorolipid;

Control group 3: sodium dodecyl sulfate;

Control group 4: the weight ratio of sophorolipid to sodium dodecyl sulfate was 10:3 (the preferred ratio of sophorolipid to sodium dodecyl sulfate). The absorbance of soaping residue was measured, and then the concentration of dye in soaping residue was calculated according to the standard curve of reactive dyes. The fastness to soaping and fastness to rubbing of soaped fabrics were measured.

TABLE 3
Influence of SL/SDBS compound system on soaping effect

| | Concentration | | | | | |
|---|---|---|---|---|---|---|
| | of soaping | Fastness to soaping | | | Fastness to rubbing | |
| | residue | | Wool | Cotton | Dry | Wet |
| Groups | (mg/L) | Discoloration | staining | staining | rubbing | rubbing |
| Experimental | 17.24 | 5 | 4-5 | 4-5 | 5 | 4-5 |
| group 1 | | | | | | |
| Experimental | 18.00 | 5 | 5 | 5 | 5 | 5 |
| group 2 | | | | | | |
| Experimental | 15.98 | 5 | 5 | 4-5 | 5 | 4-5 |
| group 3 | | | | | | |
| Control | 12.10 | 3 | 3 | 3 | 3 | 3 |
| group 1 | | | | | | |
| Control | 15.80 | 4 | 4 | 3-4 | 3-4 | 3 |
| group 2 | | | | | | |
| Control | 13.70 | 3 | 3 | 3 | 3 | 3 |
| group 3 | | | | | | |
| Control | 16.70 | 3-4 | 3-4 | 4 | 4 | 3 |
| group 4 | | | | | | |

It can be seen from the above table that different SL/SDBS compound systems have different soaping effects on dyed cotton fabrics, and the fastness to soaping and fastness to rubbing of cotton fabrics soaped by 8:2 compound soaping system are improved by about 1-2 grades.

Compared with control group 1, the soaping performance of sophorolipids combined with sodium dodecyl benzene sulfonate is significantly higher than that of sodium dodecyl benzene sulfonate, and the addition of nonionic surfactant sophorolipids weakens the charge repulsion formed by the sodium dodecyl benzene sulfonate.

Compared with control group 2, the soaping performance of sophorolipid combined with sodium dodecyl benzene sulfonate is significantly higher than that of sophorolipid. The existence of anionic surfactant sodium dodecyl benzene sulfonate reduces the steric hindrance of nonionic sophorolipid, making sophorolipid and sodium dodecyl benzene sulfonate have synergistic effect.

At the same time, compared with control groups 3 and 4, it can be seen that when sodium dodecyl sulfate is used as soaping agent, although its properties are similar to those of sodium dodecyl benzene sulfonate, the soaping performance of sophorolipid combined with sodium dodecyl benzene sulfonate is significantly higher than that of sophorolipid combined with sodium dodecyl sulfate, which indicates that sodium dodecyl benzene sulfonate can significantly improve the surface activity of sophorolipid and achieve the original soaping performance at a lower concentration.

### Experimental Example 4: Soaping Effect of SL/RL (Rhamnolipid) Compound System

A soaping process comprising the steps of hot water washing, cold water washing, soaping agent soaping, and cold water washing again.

The total concentrations of soaping agent systems in experimental group and control group were 2.0 g/L;

In the step of soaping agent soaping, the soaping liquor ratio was 1:30, the soaping time was 20 min, and the soaping temperature was 80° C.

In the step of hot water washing, the temperature was 55° C., the time was 5 min, and theliquor ratio was 1:50.

In the step of cold water washing, the temperature was 25° C., the time was 5 min, and the liquor ratio was 1:50.

Cotton fabrics dyed with reactive dyes were soaped according to the above soaping method, and were grouped according to different soaping agents. The ratio of sophorolipid to rhamnolipid in composite soaping systems of experimental groups 1, 2 and 3 were 3:7, 2:8 and 1:9, respectively.

In the control group 1, the soaping agent was rhamnolipid;

In the control group 2, the soaping agent was sophorolipid.

The absorbance of soaping residue was measured, and then the concentration of dye in soaping residue was calculated according to the standard curve of reactive dyes. The fastness to soaping and fastness to rubbing of soaped fabrics were measured.

TABLE 4
Influence of SL/RL compound system on soaping effect

| | | Concentration | | | | | |
|---|---|---|---|---|---|---|---|
| | Soaping | of soaping | Fastness to soaping | | | Fastness to rubbing | |
| | agent | residue | | Wool | Cotton | Dry | Wet |
| Grouping | (SL:RL) | (mg/L) | Discoloration | staining | staining | rubbing | rubbing |
| Experimental | 3:7 | 16.24 | 4 | 4 | 3-4 | 5 | 4 |
| group 1 | | | | | | | |
| Experimental | 2:8 | 17.74 | 5 | 5 | 5 | 5 | 5 |
| group 2 | | | | | | | |
| Experimental | 1:9 | 16.98 | 4 | 4 | 4 | 5 | 4 |
| group 3 | | | | | | | |
| Control | 0:10 | 15.50 | 3 | 3 | 3-4 | 3-4 | 3 |
| group 1 | | | | | | | |
| Control | 10:0 | 15.80 | 4 | 4 | 3-4 | 3-4 | 3 |
| group 2 | | | | | | | |

It can be seen from the above table that different SL/RL compound systems have different soaping effects on dyed cotton fabrics, and the fastness to soaping and fastness to rubbing of cotton fabrics soaped with a compound soaping system with a weight ratio of 2:8 are improved by about 1-2 grades.

Compared with the control group 1, the soaping performance of sophorolipid combined with rhamnolipid is significantly higher than that of rhamnolipid. The addition of sophorolipid weakens the charge repulsion effect formed by sodium dodecyl benzene sulfonate, improves the comprehensive performance of both, thus having a synergistic effect.

Compared with the control group 2, the soaping performance of sophorolipid combined with rhamnolipid is significantly higher than that of sophorolipid. rhamnolipid has excellent surface activity, the existence of rhamnolipid reduces the steric hindrance of sophorolipid, making sophorolipid and rhamnolipid have a synergistic effect.

### Embodiment 1: Soaping Effect of SL/SDBS/PVP (Polyvinyl Pyrrolidone) Compound System

A soaping process comprising the steps of hot water washing, cold water washing, soaping agent soaping, and cold water washing again.

The total concentrations of soaping agent system in the experimental group and the control group were 2.0 g/L;

In the step of soaping agent soaping, the soaping liquor ratio was 1:30, the soaping time was 20 min, and the soaping temperature was 80° C.

In the step of hot water washing, the temperature was 55° C., the time was 5 min, and the liquor ratio was 1:50.

In the step of cold water washing, the temperature was 25° C., the time was 5 min, and the liquor ratio was 1:50.

Cotton fabrics dyed with reactive dyes were soaped according to the above soaping method, and were grouped according to different soaping agents. The weight ratio of sophorolipid, sodium dodecyl benzene sulfonate and polyvinyl pyrrolidone in compound soaping systems of experimental groups 1, 2 and 3 were 8:2:4, 8:2:5 and 8:2:6, respectively.

At the same time, three soaping agents were selected as controls. In the control group 1, the soaping agent was sodium dodecyl benzene sulfonate;

In the control group 2, the soaping agent was soap flake (manufacturer: Shanghai Textile Industry Institute of Technical Supervision);

In the control group 3, the soaping agent was the mixture of alkyl glycoside, sodium dodecyl benzene sulfonate and polyvinyl pyrrolidone mixed according to the weight ratio of 10:3:5 (the preferred ratio of alkyl glycoside, sodium dodecyl benzene sulfonate and polyvinyl pyrrolidone).

The absorbance of soaping residue was measured, and then the concentration of dye in soaping residue was calculated according to the standard curve of reactive dyes. The fastness to soaping and fastness to rubbing of soaped fabrics were measured.

TABLE 5
Soaping effect of SL/SDBS/PVP Compound System

| | Soaping | | | | | |
|---|---|---|---|---|---|---|
| Soaping | residue | Fastness to soaping | | | Rubbingal fastness | |
| agent | concentration | | Wool | Cotton | Dry | Wet |
| (SL:SDBS:PVP) | (mg/L) | Discoloration | staining | staining | rubbing | rubbing |
| Experimental | 18.00 | 4-5 | 5 | 5 | 5 | 4-5 |
| group 1 | | | | | | |
| Experimental | 18.68 | 5 | 5 | 5 | 5 | 5 |
| group 2 | | | | | | |
| Experimental | 18.10 | 5 | 5 | 5 | 5 | 4-5 |
| group 3 | | | | | | |
| Control | 12.10 | 3 | 3 | 3 | 3 | 3 |
| group 1 | | | | | | |
| Control | 14.50 | 3 | 4 | 4 | 3 | 2 |
| group 2 | | | | | | |
| Control | 15.00 | 3-4 | 4 | 4-5 | 3-4 | 2-3 |
| group 3 | | | | | | |

It can be seen from the above table that the SL/SDBS compound soaping system solution can improve soaping effect of dyed cotton fabrics by adding the soaping auxiliary polyvinyl pyrrolidone (PVP), and the fastness to soaping and fastness to rubbing of cotton fabrics after soaping with compound soaping system added with soaping auxiliary are improved by about 1-2 grades.

In the comparison between the experimental group and the control group 3, alkyl glycoside and sophorolipid are also environmentally friendly. As a soaping agent, the soaping performance of sophorolipid combined with sodium dodecyl benzene sulfonate and polyvinyl pyrrolidone is significantly higher than that of alkyl glycoside, sodium dodecyl benzene sulfonate and polyvinyl pyrrolidone. Under the same soaping conditions, alkyl glycosides need more water for washing. When the washing liquor ratio reaches 1:80, the fastness to soaping and fastness to rubbing of fabrics are only improved by about 0.5-1 drade. It is measured that during the soaping process, the foaming height of sophorolipid of 1 g/L is 10.67 mm and that of alkyl glycoside of 1 g/L is 75 mm. It can be seen that sophorolipid has lower foamability during soaping, so the water consumption will be lower during washing, and the soaping effect can be achieved at a low water consumption level.

### Embodiment 2: Soaping Effect of SL/SDBS/PVP Compound System

A soaping process comprising the steps of hot water washing, cold water washing, soaping agent soaping, and cold water washing again.

The total concentration of soaping agent system was 1.5 g/L.

In the step of soaping agent soaping, the soaping liquor ratio was 1:20, the soaping time was 25 min, and the soaping temperature was 70° C.

In the step of hot water washing, the temperature was 55° C., the time was 5 min, and the liquor ratio was 1:55.

In the step of cold water washing, the temperature was 28-30° C., the time was 5 min, and the liquor ratio was 1:55.

Cotton fabrics dyed with reactive dyes were soaped according to the above soaping method, and were grouped according to different soaping agents, in which the weight ratio of sophorolipid, sodium dodecyl benzene sulfonate and polyvinyl pyrrolidone was 8:2:5;

Embodiment 2 is similar to Embodiment 1 in the concentration of soaping residue, and technical effects of fastness to soaping and fastness to rubbing.

### Embodiment 3: Soaping Effect of SL/RL/PVP (Polyvinyl Pyrrolidone) Compound System

A soaping process comprising the steps of hot water washing, cold water washing, soaping agent soaping, and cold water washing again.

The total concentrations of soaping agent systems in experimental group and control group were 2.0 g/L.

In the step of soaping agent soaping, the soaping liquor ratio was 1:30, the soaping time was 20 min, and the soaping temperature was 80° C.

In the step of hot water washing, the temperature was 55° C., the time was 5 min, and the liquor ratio was 1:50.

In the step of cold water washing, the temperature was 25° C., the time was 5 min, and the liquor ratio was 1:50.

Cotton fabrics dyed with reactive dyes were soaped according to the above soaping method, and were grouped according to different soaping agents. The weight ratio of sophorolipid, rhamnolipid and polyvinyl pyrrolidone in compound soaping systems of experimental groups 1, 2 and 3 were 2:8:4, 2:8:5 and 2:8:6, respectively.

In the control group 1, the soaping agent was sodium dodecyl benzene sulfonate;

In the control group 2, the soaping agent was soap flake (manufacturer: Shanghai Textile Industry Institute of Technical Supervision);

In the control group 3, the soaping agent was the mixture of alkyl glycoside, rhamnolipid and polyvinyl pyrrolidone mixed according to the weight ratio of 11:3:5 (the preferred ratio of alkyl glycoside, rhamnolipid and polyvinyl pyrrolidone).

The absorbance of soaping residue was measured, and then the concentration of dye in soaping residue was calculated according to the standard curve of reactive dyes. The fastness to soaping and fastness to rubbing of soaped fabrics were measured.

TABLE 6
Soaping effect of SL/RL/PVP compound system

| | Concentration | | | | | |
|---|---|---|---|---|---|---|
| Soaping | of soaping | Fastness to soaping | | | Fastness to rubbing | |
| agent | residue | | Wool | Cotton | Dry | Wet |
| (SL:RL:PVP) | (mg/L) | Discoloration | staining | staining | rubbing | rubbing |
| Experimental | 17.98 | 4-5 | 5 | 4-5 | 5 | 4 |
| group 1 | | | | | | |
| Experimental | 18.63 | 5 | 5 | 5 | 5 | 4-5 |
| group 2 | | | | | | |
| Experimental | 18.12 | 5 | 5 | 4-5 | 5 | 4-5 |
| group 3 | | | | | | |
| Control | 12.10 | 3 | 3 | 3 | 3 | 3 |
| group 1 | | | | | | |
| Control | 14.50 | 3 | 4 | 4 | 3 | 2 |
| group 2 | | | | | | |
| Control | 15.20 | 3-4 | 4 | 4 | 3-4 | 3 |
| group 3 | | | | | | |

It can be seen from the above table that the soaping effect of SL/RL compound soaping system solution on dyed cotton fabrics is improved after adding polyvinyl pyrrolidone (PVP), and the fastness to soaping and fastness to rubbing of cotton fabrics after soaping with compound soaping system added with soaping auxiliary are improved by about 0.5-1 grade.

### Embodiment 4: Soaping Effect of SL/RL/PVP (Polyvinyl Pyrrolidone) Compound System

A soaping process comprising the steps of hot water washing, cold water washing, soaping agent soaping, and cold water washing again.

The soaping agent was a compound system of sophorolipid, rhamnolipid and polyvinyl pyrrolidone, the weight ratio of sophorolipid, rhamnolipid and polyvinyl pyrrolidone was 2:8:5, the total concentration of the soaping agent system was 2.5 g/L.

In the step of soaping agent soaping, the soaping liquor ratio was 1:20, the soaping time was 25 min, and the soaping temperature was 60° C.

In the step of hot water washing, the temperature was 50° C., the time was 5 min, and the liquor ratio was 1:60.

In the step of cold water washing, the temperature was 25° C., the time was 5 min, and the liquor ratio was 1:60.

Embodiment 4 is similar to Embodiment 3 in the concentration of soaping residue, and technical effects of fastness to soaping and fastness to rubbing.

We claim:

1. A soaping agent, wherein, the soaping agent comprises the following raw materials in parts by weight: 1-9 parts of sophorolipid, 1-9 parts of anionic surfactant and 1-9 parts of soaping auxiliary, the anionic surfactant is either sodium dodecyl benzene sulfonate or rhamnolipid.

2. The soaping agent according to claim 1, wherein, the anionic surfactant is sodium dodecyl benzene sulfonate, and a weight ratio of the sophorolipid to the sodium dodecyl benzene sulfonate is 7-9:1-3.

3. The soaping agent according to claim 1, wherein, the soaping auxiliary is polyvinyl pyrrolidone.

4. The soaping agent according to claim 3, wherein, the anionic surfactant is sodium dodecyl benzene sulfonate, and a weight ratio of sophorolipid, sodium dodecyl benzene sulfonate and polyvinyl pyrrolidone is 7-9:1-3:4-6.

5. The soaping agent according to claim 1, wherein, the anionic surfactant is rhamnolipid, and a weight ratio of the sophorolipid to the rhamnolipid is 1-3: 7-9.

6. The soaping agent according to claim 3, wherein, the anionic surfactant is rhamnolipid, and a weight ratio of sophorolipid, rhamnolipid and polyvinyl pyrrolidone is 1-3:7-9:4-6.

7. A method for preparing the soaping agent according to claim 1, wherein, the method comprises steps of compounding the sophorolipid, the anionic surfactant and the soaping auxiliary according to a certain proportion, and shaking the solution to be uniformly mixed.

8. A method for preparing the soaping agent according to claim 7, wherein, the anionic surfactant is sodium dodecyl benzene sulfonate, and a weight ratio of the sophorolipid to the sodium dodecyl benzene sulfonate is 7-9:1-3.

9. A method for preparing the soaping agent according to claim 7, wherein, the anionic surfactant is rhamnolipid, and a weight ratio of the sophorolipid to the rhamnolipid is 1-3:7-9.

10. A method for preparing the soaping agent according to claim 7, wherein, the soaping auxiliary is polyvinyl pyrrolidone.

11. A method for preparing the soaping agent according to claim 10, wherein, the anionic surfactant is sodium dodecyl benzene sulfonate, and a weight ratio of sophorolipid, sodium dodecyl benzene sulfonate and polyvinyl pyrrolidone is 7-9:1-3:4-6.

12. A method for preparing the soaping agent according to claim 10, wherein, the anionic surfactant is rhamnolipid, and a weight ratio of sophorolipid, rhamnolipid and polyvinyl pyrrolidone is 1-3:7-9:4-6.

13. Application of the soaping agent according to claim 1 in a soaping process.

14. The application of the soaping agent in the soaping process according to claim 13, wherein, the soaping process comprises hot water washing, cold water washing, soaping agent soaping, and then cold water washing again.

15. The application of the soaping agent according to claim 14, wherein, in the step of soaping agent soaping, a total concentration of the soaping agent system is 1.0 g/L-5.0 g/L; a soaping liquor ratio is 1:10-30, soaping time is 15-25 min, and soaping temperature is 60-80° C.;
in the step of hot water washing, the temperature is 50-60° C., the time is 5-10 min, and the liquor ratio is 1:50-1:80;
in the step of cold water washing, the temperature is 20-30° C., the time is 5-10 min, and the liquor ratio is 1:50-1:80.
